(19) United States
(12) Patent Application Publication
(10) Pub. No.: US 2021/0111614 A1
(43) Pub. Date: Apr. 15, 2021

(54) ROTARY ELECTRICAL MACHINE WITH AN OPTIMISED CONFIGURATION

(71) Applicant: Valeo Equipements Electriques Moteur, Creteil Cedex (FR)

(72) Inventors: Radu Fratila, Creteil Cedex (FR); Jerome Legranger, Creteil Cedex (FR); Radhouane Khlissa, Creteil Cedex (FR)

(73) Assignee: Valeo Equipements Electriques Moteur, Creteil Cedex (FR)

(21) Appl. No.: 16/498,948

(22) PCT Filed: Mar. 22, 2018
(86) PCT No.: PCT/EP2018/057345

§ 371 Date: Sep. 27, 2019

(30) Foreign Application Priority Data
Mar. 29, 2017 (FR) 1752610

(51) Int. Cl. H02K 19/10; H02K 1/16; H02K 21/14

(52) U.S. Cl. CPC H02K 19/10; H02K 2213/03; H02K 21/14; H02K 1/16

(57) ABSTRACT

The invention relates mainly to a rotating electrical machine of a motor vehicle, comprising a rotor (12) haying an axis (X) comprising at least one permanent magnet (20) and a stator (11) surrounding the rotor and comprising a body (24) provided with a plurality of slots (30) and an electrical winding (25), the winding comprising phase windings (26) arranged in the slots, each phase winding being formed by at least one conductor (35). The rotor (12) comprises 3, 4 or 5 pairs of poles. The stator comprises two three-phase systems, each formed by three delta connected phase windings (26). The number of conductors (35) per slot (30) is strictly greater than 2 and each conductor has an active portion (40) inserted in a corresponding slot (30), the active portion with a substantially rectangular section being of is radial length (L2) smaller than or equal to 3.6 mm.

The present invention relates to a rotary electrical machine with an optimised configuration.

The invention has a particularly advantageous, but non-exclusive application with high-power reversible electrical machines which can operate in alternator mode and in motor mode, coupled with a host element, such as a gearbox.

In a known manner, rotary electrical machines comprise a stator and a rotor integral with a shaft. The rotor can be integral with a driving and/or driven shaft, and can belong to a rotary electrical machine in the form of an alternator, an electric motor, or a reversible machine which can operate in both modes. In alternator mode, when the rotor is rotating, it induces a magnetic field on the stator, which transforms this field into electric current, in order to supply the electrical consumers of the vehicle with power and recharge the battery. In motor mode, the stator is supplied electrically and induces a magnetic field which rotates the rotor in order to start the thermal engine and/or participate in the traction of the vehicle, autonomously or in combination with the thermal engine.

The stator is fitted in a housing which is configured to rotate the shaft on bearings by means of roller bearings. In addition, the stator comprises a body constituted by a stack of thin metal plates forming a crown, the inner face of which is provided with notches open towards the interior in order to receive an electrical winding formed by phase windings. These windings pass through the notches in the body of the stator, and form chignons which project on both sides of the body of the stator. The phase windings are obtained for example from a continuous wire covered with enamel, or from conductive elements in the form of pins connected to one another by welding. These windings are polyphase windings connected in the form of a star or a triangle, the outputs of which are connected to an inverter which also operates as a rectifier bridge.

With this type of machine, the speed of rotation of the machine affects the voltage supplied, and therefore the power of the machine. Thus, the higher the speed of rotation, the greater the power is. For synchronous machines, beyond a certain speed of rotation, in order to maximise the power of the machine, it is important to be able to deflux the said machine. FIG. 1 represents characteristic torque and power curves according to the speed of rotation of an electrical machine of this type, rotating respectively in the motor mode M_mth (cf. characteristic torque curve C1 and characteristic power curve C2) and in the generator mode M_gen (cf. characteristic torque curve C3 and characteristic power curve C4). A defluxing range P_def is defined by reference to a ratio between a maximal speed of rotation at constant torque N1 divided by the maximal speed of rotation N2 of the electrical machine. Since this defluxing ratio is high (greater than 2.5), the machine can operate at high speed whilst being in a state of quasi short-circuit.

In order to optimise the operation of the machine, in particular in order to be able to reach high speeds of operation and therefore high power, it is necessary for the machine to have good resistance to the short-circuit current in a steady-state. This optimisation of the machine must also take into account other parameters such as the compactness of the machine, which is an important parameter for the integration of the said machine in the vehicle, as well as the thermal performance of the machine, which is also an important parameter, both for the safety of the users, and in order not to damage the machine. The objective of the invention is thus to guarantee the resistance to the short-circuit current in the steady-state, whilst optimising the compactness and thermal characteristics of the electrical machine.

For this purpose, the subject of the present invention is a rotary electrical machine of a motor vehicle. According to the invention, the machine comprises a rotor which extends along an axis of rotation, and comprises at least one permanent magnet, and a stator which surrounds the rotor and comprises a body provided with a plurality of notches and an electrical winding, with the winding comprising phase windings disposed in the notches, each phase winding being formed by at least one conductor. In addition, according to the invention, the rotor comprises 3 or 4 or 5 pairs of poles, and the stator comprises two three-phase systems each formed by three phase windings with delta coupling. In addition, according to the invention, the number of conductors per notch is strictly greater than 2, and each conductor has an active portion inserted in a corresponding notch, the active portion with a substantially rectangular cross-section having a radial length of 3.6 mm or less.

The fact of having two three-phase systems makes it possible to simplify the arrangement of the power modules, and therefore makes it possible to obtain a machine which can be more compact. In addition, the coupling of the windings in the form of a triangle makes it possible not to have a neutral point, and therefore improves the compactness of the machine. The fact of having a substantially rectangular cross-section of wire makes it possible to improve the coefficient of filling of the conductors in the notches, and therefore to improve the power of the machine. Substantially rectangular cross-section means the fact that the corners of the conductors can be slightly rounded for production reasons. A number of conductors per notch which is strictly greater than two makes it possible to obtain a greater degree of latitude in terms of the choice of the number of turns per winding. In addition, the fact that the radial width of the conductors is 3.6 mm or less, associated with a number of pairs of poles of the rotor of between 3 and 5, makes it possible to minimise the resistance of the conductors, in order thus to limit the Joule losses of the conductors. All of these parameters taken together therefore give rise to improved thermal resistance, improved resistance to the short-circuit current in a steady-state, and improved compactness of the rotary electrical machine. The rotary electrical machine can thus operate safely at a higher speed.

According to one embodiment, the two three-phase systems are independent from one another, and the rotary electrical machine comprises an inverter comprising two independent modules which are each connected to a three-phase system.

According to one embodiment, the inverter is connected to a direct current bus with a voltage of between 30 and 60 V.

According to one embodiment, an orthoradial length of an active portion of the conductor is 1.4 mm or more.

According to one embodiment, an outer diameter of the stator body is between 80 mm and 180 mm For example, the outer diameter of the stator body is selected from amongst one of the following values: 80, 90, 100, 110, 153, 161 and 180 mm.

According to one embodiment, a maximal power of the said rotary electrical machine is between 8 kW and 30 kW.

According to one embodiment, the number of conductors per notch is even.

According to one embodiment, the number of conductors per notch is equal to 4. As a variant, the number of conductors per notch can be equal to 6, 8 or also 10.

According to one embodiment, the conductors are aligned radially relative to one another in the interior of a corresponding notch.

According to one embodiment, each phase winding is formed from a plurality of conductors which in particular are in the form of pins connected electrically to one another. For example the pins extend in the form of a “U” comprising two active parts extending in respective notches, and a connection portion which connects the two active parts. Preferably, a phase winding is formed by welding to one another the free ends of the active parts of different pins. Free ends means the ends of the active parts which are not connected to the connection portion.

According to one embodiment, each phase winding is formed from a continuous conductor. This continuous conductor is for example a wire.

According to one embodiment, the conductor wire comprises active portions with a substantially rectangular cross-section, and portions of connection between two adjacent active portions with a cross-section which is rounded, and in particular substantially round.

According to one embodiment, the conductors have a rectangular cross-section with rounded corners.

According to one embodiment, the said rotary electrical machine comprises a cooling liquid circuit.

According to one embodiment, the machine is a synchronous machine.

According to one embodiment, the machine is a machine with permanent magnets.

According to one embodiment, the said rotary electrical machine is in the form of a rotor, a generator, or a reversible electrical machine.

The invention will be better understood by reading the following description and examining the figures which accompany it. These figures are provided purely by way of illustration, and in no way limit the invention.

FIG. 1, already described, shows the characteristic torque and power curves according to the speed of rotation of a rotary electrical machine used within the context of the invention.

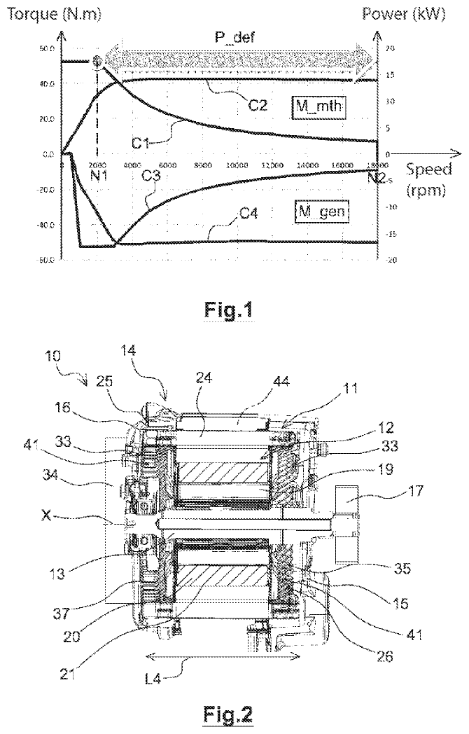

FIG. 2 is a view in longitudinal cross-section of a rotary electrical machine according to an embodiment of the present invention.

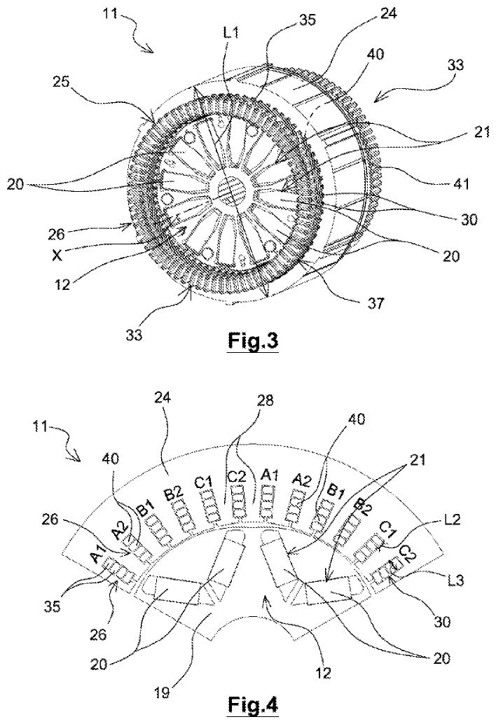

FIG. 3 is a view in perspective of the wound stator and of the rotor of the rotary electrical machine in FIG. 2.

FIG. 4 is a view in partial transverse cross-section of the rotor and of the wound stator according to an embodiment of the present invention.

FIG. 5 shows graphic representations of the development of the ratio between the resistance of an electrical high-frequency stator conductor and the resistance of an electrical low-frequency stator conductor according to the radial dimension of an active portion of a stator conductor, respectively for a rotor with 3 and 5 pairs of poles.

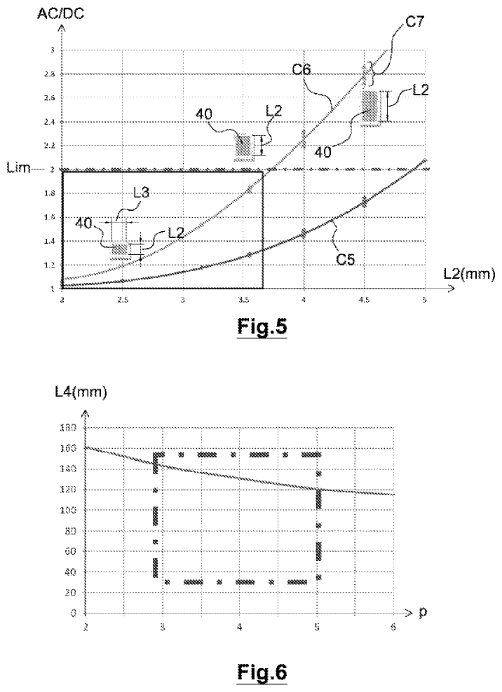

FIG. 6 represents the development of the total axial height of the rotary electrical machine according to the number of pairs of poles of the rotor.

Elements which are identical, similar or analogous retain the same reference from one figure to another.

Hereinafter in the description, a “front” element means an element which is situated on the side of the drive part, such as on the side of the pinion supported by the shaft of the machine, and “rear” element means an element which is situated on the opposite side relative to the axis of rotation X of the machine.

FIG. 2 shows a rotary electrical machine 10 comprising a polyphase stator 11 surrounding a rotor 12 fitted on a shaft 13 extending along an axis X corresponding to the axis of the machine. The stator 11 surrounds the rotor 12 with the presence of an air gap between the inner periphery of the stator 11 and the outer periphery of the rotor 12. The stator 11 is fitted in a housing 14 provided with a front bearing 15 and a rear bearing 16 which supports the shaft 13 with rotation.

This electrical machine 10 can be designed to be coupled to a gearbox belonging to a motor vehicle traction chain. In another configuration, the electrical machine 10 can be coupled to a crankshaft of the vehicle, or also directly to the traction chain of the wheels of the vehicle. For example, the machine 10 can be coupled to a part of the vehicle by a pinion 17 as represented in FIG. 2. As a variant, the machine 10 can be coupled to a part of the vehicle by a pulley or any other coupling means.

The machine 10 can operate in an alternator mode, in order in particular to supply energy to the battery and to the on-board network of the vehicle, and in a motor mode, not only in order to ensure the starting of the thermal engine of the vehicle, but also to participate in the traction of the vehicle, alone or in combination with the thermal engine. As a variant, the electrical machine 10 can be implanted on an axle of the motor vehicle, in particular a rear axle. As a variant, the electrical machine 10 is in the form of an electric motor or a non-reversible generator. The power of the electrical machine 10 is advantageously between 8 kW and 30 kW.

In the example in FIG. 2, the rotor 12 comprises a body 19 in the form of a set of metal plates. Permanent magnets 20 can be implanted in the interior of cavities 21 according to a configuration in the form of a “V”, as illustrated in FIG. 4, or they can be implanted radially in the interior of the set of metal plates, and the lateral faces opposite one another of two consecutive magnets 20 can have the same polarity, as illustrated in FIG. 3. The rotor 12 is then of the flux concentration type. Alternatively, the permanent magnets 20 extend orthoradially in the interior of the cavities 21 in the body 19. The magnets 20 can be made of rare earth or ferrite, according to the applications and the power required from the machine 10.

In addition, as can be seen in FIGS. 3 and 4, the stator 11 comprises a body 24 constituted by a set of metal plates, as well as an electrical winding 25. The body 24 is formed by a stack of metal plate sheets which are independent from one another, and are retained in the form of a set by means of an appropriate securing system. As can be seen in FIG. 4, the body 24 is provided with teeth 28, which delimit in pairs notches 30 for the fitting of the stator winding 25. Thus, two successive notches 30 are separated from one another by a tooth 28. Preferably, an outer diameter L1 of the stator body 24 is between 80 and 180 mm. Advantageously, the outer diameter L1 of the stator body 24 is selected from amongst one of the following values: 80, 90, 100, 110, 153, 161 and 180 mm.

The winding 25 comprises an assembly of phase windings 26 which pass through the notches 30 and form chignons 33 extending projecting on both sides of the stator body 24, as shown in FIGS. 2 and 3. The outputs of the phase windings 26 are connected to an inverter 34, which can also operate as a rectifier bridge. For this purpose, the inverter 34 comprises power modules provided with power switching elements, such as transistors of the MOS type, connected to the phase outputs.

Each phase winding 26 can be formed from a plurality of conductors 35 constituted by pins 37. These pins 37 can have the form of a “U”, the ends of the branches of which are connected to one another for example by welding. As a variant, each phase winding 26 is formed from a continuous conductive wire wound in the interior of the stator 11 in the notches 30, in order to form one or a plurality of turns. In all cases, a distinction is made between the active portions 40 of a conductor 35 situated in the interior of the notches 30, and connection portions 41 which connect two adjacent active portions 40 to one another. The active portions 40 thus correspond to the portions of the conductors 35 which extend axially in the interior of the notches 30, whereas the connection portions 41 extend circumferentially in the interior of the chignons 33, in order to connect the active portions 40 to one another. The conductors 35 can for example be made of a material based on enamelled copper.

The phase windings 26 are each associated with a series of notches 30, such that each notch 30 receives several times the conductors 35 of the same phase. Advantageously, the stator 11 comprises two three-phase systems which are preferably independent, i.e. A1, B1, C1 and A2, B2, C2 each formed by three phase windings 26, as illustrated in FIG. 4. This makes it possible to guarantee the compactness of the inverter 34 by facilitating the arrangement of the power modules of the inverter 34 in a cylinder which is situated at the rear of the machine for the integrated systems (cf. FIG. 2) or in a substantially parallelepiped volume on the side of the machine 10.

Each three-phase system A1, B1, C1; A2, B2, C2 is coupled in the form of a triangle in order to optimise the compactness of the electrical machine 10. In fact, in comparison with a coupling of the double star type, the double triangle coupling makes it possible to avoid the integration of the neutral bars in the wound stator 11, which are relatively cumbersome.

Each three-phase system A1, B1, C1; A2, B2, C2 is connected electrically to an independent module of the inverter 34. Each independent module comprises power elements and a control module which is dedicated to the corresponding three-phase system. The two independent modules are accommodated in a single casing of the inverter 34 which tops the rear bearing. The inverter 34 is preferably connected to a direct current bus with a voltage of between 30 and 60 V.

In this example, two consecutive notches 30 of a series associated with a phase are separated by adjacent notches 30 each corresponding to another series of notches associated with one of the other phases. Thus, when there are K phases, the conductors 35 of a single phase winding 26 are all inserted every K+1 notches. For example, if the winding of the phase A1 is inserted in notch no. 1, it is then inserted in the 7^{th} notch for a machine with two three-phase systems, i.e. K=6. It should be noted that, in the configuration represented in FIG. 4, the phases of the two systems alternate according to the circumference of the stator 11. In this example, taking into consideration the circumferential direction, the first notch comprises the phase A1, the second notch comprises the phase A2, the third notch comprises the phase B1, the fourth notch comprises the phase B2, the fifth notch comprises the phase C1, and the sixth notch comprises the phase C2. According to a variant embodiment, another phase configuration can be envisaged.

The conductors 35 advantageously have a substantially rectangular cross-section, at least in their active portion 40, and they are aligned radially relative to one another in the interior of the corresponding notch 30. A winding configuration of this type arranged with conductors 35 with a substantially rectangular cross-section makes it possible to reduce the height of the chignons 33, and assists the compactness of the machine in comparison with a random winding made of round wire. According to a particular embodiment of winding with continuous wire, the conductive wires can be pressed only in the active portions 40, and have a round cross-section in the connection portions 41. The substantially rectangular cross-section of the active portions 40 can have rounded corners in order not to damage the enamel As a variant, the conductors 35 can have a substantially square cross-section.

The number of conductors 35 in the interior of each notch 30 is advantageously strictly more than two in order to have a degree of freedom in terms of the choice of the number of turns per phase winding 26. Preferably, the number of conductors 35 per notch is even. In this case it is equal to 4, but as a variant it could be different, and in particular equal to 6, 8 or 10.

At a high electrical frequency and therefore at a high speed of rotation, the conductors 35 are subjected to pellicular and proximity effects which result in making the density of current non-uniform in the conductor 35. This leads to an increase in the apparent resistance of the conductor 35. This increase in resistance is conventionally quantified by a ratio between the AC resistance at high-frequency and the DC resistance of the same conductor 35 at a very low frequency of a few Hertz.

The electrical resistance therefore depends on the temperature, the dimensions of the stator 11, the dimensions of the conductors, and the electrical frequency fe, which is associated with the speed of rotation N in revolutions per minute of the machine by means of the following formula: fe=(N×p)/60, p being the number of pairs of poles of the rotor 12.

The increase in this resistance gives rise to additional Joule losses, and involves an increase in the size of the electrical machine 10 in order to be able to discharge the calories, for example by increasing the size of a cooling liquid chamber 44 described in greater detail hereinafter.

The main factor which affects the AC resistance is the radial length L2 of the conductor 35 in the interior of the notch 30, as well as the electrical frequency fe which is associated with the polarity of the rotor 12 for the same speed of rotation.

For an electrical machine 10 with a stator diameter L1 of approximately 160 mm and a speed of rotation of 20,000 rpm, FIG. 5 represents the development of the ratio between the AC resistance of a stator conductor at a high frequency and the DC resistance of this stator conductor 35 at a low frequency according to the radial length L2 of the active portion 40 of a conductor 35, respectively for a rotor with 3 pairs of poles (cf. curve C5) and with 5 pairs of poles (cf. curve C6).

It is found that, for a given limit Lim of losses which can be discharged by the electrical machine 10, the maximal radial length L2 of the conductor 35 is 3.6 mm for a machine with five pairs of poles. A value of this type guarantees adequate performance for a machine with three pairs of poles, the AC/DC ratio of which is globally lower than that of the machine with five pairs of poles.

In addition, the orthoradial length L3 of an active portion 40 is 1.4 mm or more. This length L3 has little effect on the AC resistance of the conductors 35. In fact, as can be seen in FIG. 5 by means of the different points C7, for a given radial length L2, and by varying the orthoradial length L3 of the conductors 35, the value of the AC/DC ratio varies only very slightly.

FIG. 6 represents the development of the total axial height L4 of the stator 11 of the electrical machine (cf. FIG. 2) according to the number of pairs of poles p of the rotor 12. Axial height means the distance between the two ends of the front and rear chignons 33. This figure shows that a rotor 12 with fewer than three pairs of poles leads to an increase in the total height L4 of the machine, since the height of the chignons 33 is substantially proportional to the polarity. In fact, the fewer poles there are in the machine, the more the distance between the poles increases. Thus, the notches through which a single phase winding passes are further apart from one another, and the portions of the conductors which form the chignons must therefore be larger. On the other hand, a polarity of more than five pairs of poles gives rise to too many losses. In these conditions, the optimal polarity is between 3 and 5 pairs of poles, i.e. the rotor 12 can comprise 3 or 4 or 5 pairs of poles.

The rotary electrical machine 10 can comprise a cooling liquid circuit comprising a cooling liquid input and output in order to make the liquid circulate in a chamber 44 provided on the outer periphery of the stator 11 as shown in FIG. 2. The electrical machine 10 can thus be cooled by water or by oil. According to a variant embodiment, the machine can be cooled by air, for example by means of a fan.

It will be appreciated that the foregoing description has been provided purely by way of example and does not limit the scope of the invention, a departure from which would not be constituted by replacing the different elements by any other equivalents.

In addition, the different characteristics, variants, and/or embodiments of the present invention can be associated with one another according to different combinations, provided that they are not incompatible or mutually exclusive.

1. A rotary electrical machine of a motor vehicle, comprising:
a rotor which extends along an axis of rotation comprising at least one permanent magnet; and
a stator which surrounds the rotor and comprises a body provided with a plurality of notches and an electrical winding, with the winding comprising phase windings disposed in the notches, each phase winding being formed by at least one conductor,
wherein, in the rotary electrical machine:
the rotor comprises 3 or 4 or 5 pairs of poles,
the stator comprises two three-phase systems each formed by three phase windings with delta coupling, and
the number of conductors per notch is greater than 2, and each conductor has an active portion inserted in a corresponding notch, the active portion with a substantially rectangular cross-section having a radial length of 3.6 mm or less.

2. The rotary electrical machine according to claim 1, wherein the two three-phase systems are independent from one another, the machine further comprising an inverter comprising two independent modules which are each connected to a three-phase system.

3. The rotary electrical machine according to claim 2, wherein the inverter is connected to a direct current bus with a voltage of between 30 and 60 V.

4. The rotary electrical machine according to claim 1, wherein an orthoradial length of an active portion of a conductor is 1.4 mm or more.

5. The rotary electrical machine according to claim 1, wherein an outer diameter of the stator body is between 80 mm and 180 mm.

6. The rotary electrical machine according to claim 5, wherein the outer diameter of the stator body is selected from amongst one of the following values: 80, 90, 100, 110, 153, 161 and 180 mm.

7. The rotary electrical machine according to claim 1, wherein a maximal power of the said rotary electrical machine is between 8 kW and 30 kW.

8. The rotary electrical machine according to claim 1, wherein the number of conductors per notch is even.

9. The rotary electrical machine according to claim 8, wherein the number of conductors per notch is equal to 4.

10. The rotary electrical machine according to claim 1, wherein the conductors are aligned radially relative to one another in the interior of a corresponding notch.

11. The rotary electrical machine according to claim 1, wherein each phase winding is formed from a plurality of conductors which are in the form of pins connected electrically to one another.

12. The rotary electrical machine according to claim 1, wherein each phase winding is formed from a continuous conductor.

13. The rotary electrical machine according to claim 1, wherein the rotary electrical machine it is in the form of a rotor, a generator, or a reversible electrical machine.
